(19) United States
(12) Patent Application Publication
(10) Pub. No.: US 2007/0091482 A1
(43) Pub. Date: Apr. 26, 2007

(54) Variable-shape mirror and optical pickup apparatus therewith

(75) Inventors: Hideki Chouji, Osaka (JP); Shigeo Maeda, Osaka (JP); Hidetoshi Kotera, Kyoto (JP); Isaku Kanno, Kyoto-shi (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/585,861

(22) Filed: Oct. 25, 2006

(30) Foreign Application Priority Data
Oct. 26, 2005 (JP) 2005-310839
Oct. 10, 2006 (JP) 2006-276274

(51) Int. Cl. G02B 5/08

(52) U.S. Cl. 359/846; 359/290

(57) ABSTRACT

A variable-shape mirror has a substrate, a lower electrode film formed on the substrate, a piezoelectric film formed on the lower electrode film, an upper electrode film formed on the piezoelectric film, and a mirror film formed directly on the substrate and arranged to be surrounded by a driver portion constituted by the lower electrode film, the piezoelectric film, and the upper electrode film. The mirror film is arranged on a movable portion provided in the substrate, and at least part of the driver portion is arranged on the movable portion.

This application is based on Japanese Patent Application No. 2005-310839 filed on Oct. 26, 2005 and Japanese Patent Application No. 2006-276274 filed on Oct. 10, 2006, the contents of which are hereby incorporated by reference.

### BACKGROUND OF THE INVENTION

1. Field of the Invention

The present invention relates to a variable-shape mirror, i.e. a mirror that can vary the mirror surface shape thereof, for use in an optical pickup device or the like, and more particularly to a variable-shape mirror that is so structured as to have a plurality of thin films formed on one another. The present invention also relates to an optical pickup apparatus incorporating such a variable-shape mirror.

2. Description of Related Art

When information is read from or written to an optical disc such as a CD (compact disc) or DVD (digital versatile disc) by use of an optical pickup device, the relationship between the optical axis of the optical pickup device and the disc surface should ideally be perpendicular. In reality, however, while the disc is rotating, the relationship does not remain perpendicular all the time. Thus, with an optical disc such as a CD or DVD, when the disc surface slants relative to the optical axis, the optical path of the laser light bends, producing wavefront aberrations (mainly coma aberration). Also when optical discs to which to record information or from which to retrieve information by use of an optical pickup apparatus are exchanged, differences in the thickness of the disc substrate from one optical disc to another produce wavefront aberrations (mainly spherical aberration).

When such wavefront aberrations occur, the position of the spot of the laser light shone on the optical disc deviates from the right position. When the wavefront aberrations are larger than are tolerated, inconveniently, it is no longer possible to read or write information correctly. For this reason, conventionally, variable-shape mirrors have been used to correct for wavefront aberrations, and various variable-shape mirrors have been proposed.

For example, JP-A-2002-279677 proposes a variable-shape mirror formed with a thin silicon substrate and a thin piezoelectric film. Here, a mirror surface is provided on one side of the silicon substrate, and an insulating layer is formed on the other side of the silicon substrate. Moreover, of the electrodes formed on both sides of the thin piezoelectric film, at least the one on one side is divided into discrete segments so that the shape of the mirror surface is varied according to the pattern of the divided electrode segments.

Disadvantageously, however, with the variable-shape mirror structured as proposed in JP-A-2002-279677 mentioned above, the piezoelectric film and the electrodes for driving it are formed on the thin silicon substrate. This results in very poor handling of the variable-shape mirror during its fabrication, leading to low work efficiency, and even causes breakage of the variable-shape mirror during fabrication.

Speaking of handling, the variable-shape mirrors proposed in JP-A-2005-032286 and JP-A-2004-151631 fare better because here, of the substrate that forms the mirror surface, only the part where the mirror needs to be moved is formed thin. According to JP-A-2005-032286, in a variable-shape mirror as shown in FIG. 6, a reflective film 101 is formed on the bottom side of a substrate 105 where a circular cavity is provided. Moreover, on the top side of the substrate 105, there are formed a lower electrode 103, a piezoelectric film 102, and an upper electrode 104 divided into discrete segments.

On the other hand, according to JP-A-2004-151631, as shown in FIG. 7, a mirror member 201 is formed on the side of a mirror substrate 205 that is not processed by etching, and, on the side thereof that is processed by etching, there are formed a piezoelectric element 202, electrodes 203a and 204a for applying a voltage across the piezoelectric element 202, and wiring electrodes 203b and 204b. Here, the wiring electrodes 203b and 204b are formed as a sputtered Al film, which is first formed over the entire bottom side of the mirror substrate 205 and is then patterned by photolithography process.

Disadvantageously, however, when a mirror surface is formed on the side of a substrate that is processed by etching or the like as proposed by JP-A-2005-032286 mentioned above, since such a processed surface is poor in flatness and smoothness, it is difficult to obtain a flat and smooth mirror surface. Without a flat and smooth mirror surface, it is difficult to accurately correct for aberrations with the variable-shape mirror.

On the other hand, according to JP-A-2004-151631 mentioned above, since a mirror surface is formed on the side of a substrate that is not processed by etching, it is possible to obtain a flat and smooth mirror surface indeed, but it is necessary to form an electrode pattern on the side that is processed by etching. Disadvantageously, it is difficult to pattern an electrode conductor on such a processed surface.

### SUMMARY OF THE INVENTION

In view of the conventionally experienced inconveniences mentioned above, it is an object of the present invention to provide a variable-shape mirror that, despite being so structured as to have a plurality of thin films formed on one another, offers a flat and smooth mirror surface and is easy to fabricate. It is another object of the present invention to provide an optical pickup apparatus that can correct for aberrations accurately and that can be fabricated with less work burden as a result of the optical pickup apparatus incorporating a variable-shape mirror that offers a flat and smooth mirror surface and is easy to fabricate.

To achieve the above objects, according to the present invention, a variable-shape mirror is provided with: a driver portion including a piezoelectric film and first and second electrode films that sandwich the piezoelectric film therebetween; a substrate supporting the driver portion and having part thereof formed into a movable portion by being made thinner; a mirror film formed directly on the movable portion so that, as the driver portion is driven, the mirror film varies the shape thereof. Here, the mirror film is formed on the side of the substrate opposite from the side thereof processed to form the movable portion, and is formed so as not to overlap the driver portion or so as to be integral with one of the first and second electrode films. Moreover, at least part of the driver portion is provided on the movable portion.

With this structure, the driver portion, which is constituted by the piezoelectric film and the two electrode films sandwiching it, is arranged on part of the movable portion formed by making part of the substrate thinner; thus, when a voltage is applied to the electrodes and the driver portion is thereby driven, the mirror surface, which is arranged on the movable portion, can easily vary its shape. Moreover, in this variable-shape mirror so structured as to have a plurality of thin films formed on one another, the driver portion and the mirror film are both formed on the side of the substrate that is not processed. This makes it possible to obtain a flat and smooth mirror surface, and makes it easy to form an electrode pattern on the substrate.

Moreover, according to the present invention, in the variable-shape mirror structured as described above, the driver portion may be arranged around the mirror film.

This structure permits the shape of the mirror film to be varied efficiently by the driver portion, and allows easy fabrication.

Moreover, according to the present invention, in the variable-shape mirror structured as described above, the driver portion may be arranged so as to surround the outer circumference of the mirror film.

This structure permits the shape of the mirror film to be varied efficiently into the desired shape.

Moreover, according to the present invention, in the variable-shape mirror structured as described above, at least one of the first and second electrode films has a pattern divided into a plurality of discrete segments.

This structure, where at least one of the electrodes is divided into a plurality of discrete segments, helps realize a variable-shape mirror that can correct for aberrations by sole use of a piezoelectric film whose piezoelectric polarity is unidirectional.

Moreover, according to the present invention, an optical pickup apparatus is provided with the variable-shape mirror structured as described above.

With this structure, incorporating a variable-shape mirror having a flat and smooth mirror surface, the optical pickup apparatus can correct for aberrations accurately. Moreover, since the variable-shape mirror can be fabricated easily, the optical pickup device can be fabricated with less work burden.

### BRIEF DESCRIPTION OF THE DRAWINGS

FIG. 1 is a schematic diagram showing the construction of the optical system of an optical pickup apparatus embodying the present invention;

FIG. 2A is a diagram showing the structure of the variable-shape mirror incorporated in the optical pickup apparatus embodying the present invention, the diagram being a schematic front view of the variable-shape mirror as seen from the mirror surface side thereof;

FIG. 2B is a schematic cross-sectional view along line A-A shown in FIG. 2A;

FIG. 2C is a diagram showing the variable-shape mirror shown in FIG. 2A as seen from the bottom side thereof;

FIG. 3 is a schematic plan view showing the structure of the lower electrode of the variable-shape mirror of the embodiment;

FIG. 4 is a diagram showing the operation of the variable-shape mirror of the embodiment, in a state where the piezoelectric film has expanded;

FIG. 5 is a diagram showing the operation of the variable-shape mirror of the embodiment, in a state where the piezoelectric film has contracted;

FIG. 6 is a diagram showing the structure of a conventional variable-shape mirror;

FIG. 7 is a diagram showing the structure of a conventional variable-shape mirror; and

FIG. 8 is a diagram showing a modified example of a variable-shape mirror according to the present invention.

### DETAILED DESCRIPTION OF PREFERRED EMBODIMENTS

Hereinafter, an embodiment of the present invention will be described with reference to the drawings. It should however be understood that the embodiments presented below are merely examples and are not meant to limit the present invention in any way.

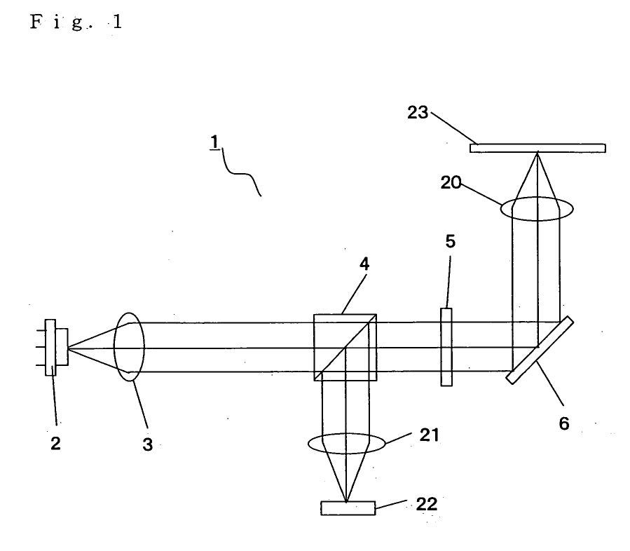

FIG. 1 is a schematic diagram showing the construction of the optical system of an optical pickup apparatus incorporating a variable-shape mirror embodying the present invention. In FIG. 1, the optical pickup apparatus 1 is capable of, on one hand, irradiating an optical recording medium 23, such as a CD, DVD, or blue-laser DVD (a high-capacity, high-definition DVD), with a laser beam and receiving the light reflected therefrom in order to read the information recorded on a recording surface of the recording medium 23 and, on the other hand, irradiating the recording medium 23 with a laser beam in order to write information to a recording surface thereof. The optical pickup apparatus 1 includes, for example, a laser light source 2, a collimator lens 3, a beam splitter 4, a quarter-wave plate 5, a variable-shape mirror 6, an objective lens 20, a condenser lens 21, and a photodetector 22.

The laser light source 2 is a semiconductor laser diode that emits a laser beam of a predetermined wavelength. Used here is, for example a semiconductor laser diode that can emit a laser beam of a wavelength of 785 nm for CDs, 650 nm for DVDs, or 405 nm for blue-laser DVDs. In the embodiment, it is assumed that a single laser light source 2 emits a laser beam of a single wavelength; it is however also possible to use instead a laser light source that can emit laser beams of a plurality of wavelengths. The laser beam emitted from the laser light source 2 is directed to the collimator lens 3.

The collimator lens 3 converts the laser beam emitted from the laser light source 2 into a parallel light beam. The parallel light beam here is so called because all the rays constituting the beam, which originates from the laser light source 2, are approximately parallel to the optical axis. The parallel light beam transmitted through the collimator lens 3 is then directed to the beam splitter 4.

The beam splitter 4, on one hand, transmits the laser beam transmitted through the collimator lens 3 and, on the other hand, reflects the laser beam reflected back from the recording medium 23 to direct it to the photodetector 22. The laser beam transmitted through the beam splitter 4 is directed to the quarter-wave plate 5.

The quarter-wave plate 5 cooperates with the beam splitter 4 to function as a light isolator. The laser beam transmitted through the quarter-wave plate 5 is directed to the variable-shape mirror 6.

The variable-shape mirror 6 is inclined, for example, at 45 degrees relative to the optical axis of the laser beam emitted from the laser light source 2. The variable-shape mirror 6 reflects the laser beam transmitted through the beam splitter 4 to direct it to the objective lens 20. The variable-shape mirror 6 also corrects for wavefront aberrations in the laser beam by varying the shape of the mirror surface provided therein. The structure of the variable-shape mirror 6 will be described in detail later.

The objective lens 20 focuses the laser beam reflected from the variable-shape mirror 6 on an information recording surface formed inside the recording medium 23.

The laser beam reflected from the recording medium 23 is transmitted through the objective lens 20, and is then reflected on the variable-shape mirror 6. The laser beam reflected from the variable-shape mirror 6 is then transmitted through the quarter-wave plate 5, is then reflected on the beam splitter 4, and is then directed to the condenser lens 21. The condenser lens 21 focuses the laser beam reflected from the recording medium 23 on the photodetector 22.

On receiving the laser beam, the photodetector 22 converts optical information into an electrical signal, which it then feeds to an RF amplifier or the like provided in an unillustrated optical disc apparatus or the like. This electrical signal contains information retrieved from the data recorded on the recording surface and information (servo information) needed to control the position of the optical pickup apparatus 1 as a whole and of the position of the objective lens 20.

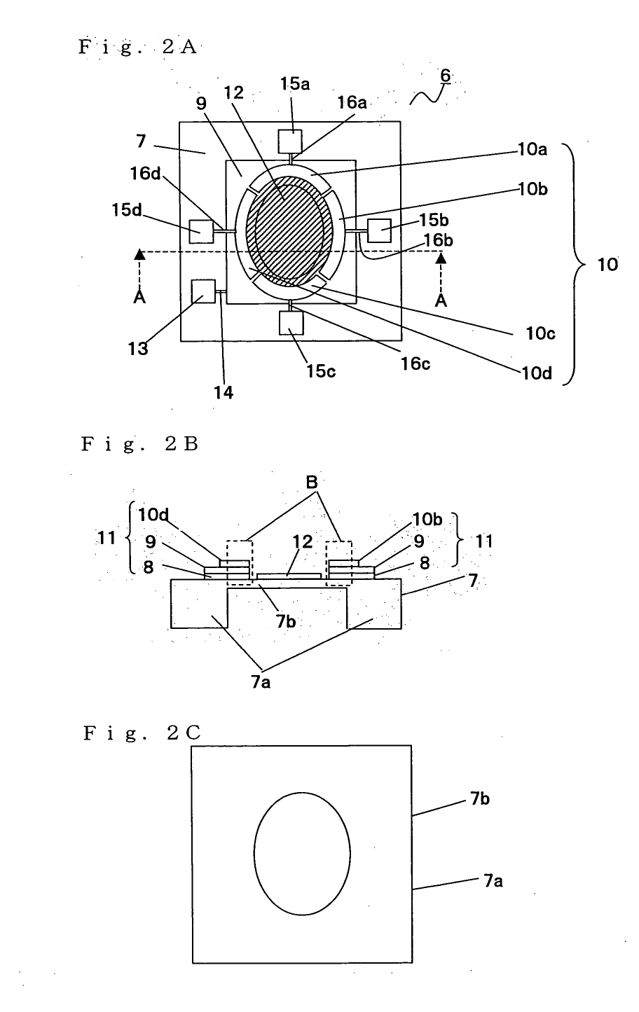

Next, the structure of the variable-shape mirror 6 used in the embodiment will be described in detail. FIG. 2A is a diagram showing the structure of the variable-shape mirror 6 used in the optical pickup apparatus 1 of the embodiment, the diagram being a schematic front view of the variable-shape mirror 6 as seen from the mirror surface side thereof. FIG. 2B is a schematic cross-sectional view along line A-A shown in FIG. 2A. FIG. 2C is a diagram showing the variable-shape mirror 6 shown in FIG. 2A as seen from the bottom side thereof.

As shown in FIGS. 2A to 2C, in the embodiment, the variable-shape mirror 6 includes a substrate 7, a lower electrode film 8 formed on the substrate 7, a piezoelectric film 9 formed on the lower electrode film 8, an upper electrode film 10 formed on the piezoelectric film 9, and a mirror film 12 formed directly on the substrate 7 and arranged so as to be surrounded by a driver portion 11 constituted by the lower electrode film 8, the piezoelectric film 9, and the upper electrode film 10.

The substrate 7 serves to support the driver portion 11 and the mirror film 12. The substrate 7 is composed of a thick portion 7a and a thin portion 7b, and the thin portion 7b serves as a movable portion (hereinafter, the movable portion will be referred to by reference numeral 7b). How the movable portion 7b moves will be described later. The movable portion 7b is formed, for example, by etching away or otherwise removing part of the substrate 7, which is originally formed as a thick plate. In the embodiment, the movable portion 7b is oval. This however is not meant to be any limitation; its shape may be modified within the objects of the present invention. For example, the movable portion 7b may be rectangular or of any other shape. Likewise, although the substrate 7 is rectangular in the embodiment, this is not meant to be any limitation; it may be circular, polygonal, or of any other shape.

The substrate 7 is formed of, for example, an insulating material such as glass or ceramic, although no particular limitation is meant thereby. To enhance the piezoelectric properties of the piezoelectric film 9, however, it is preferable that the substrate 7 be formed of, for example, silicon or magnesium oxide. Where the substrate 7 is not formed of an insulating material, an insulating layer formed of an insulating material needs to be formed between the substrate 7 and the lower electrode film 8.

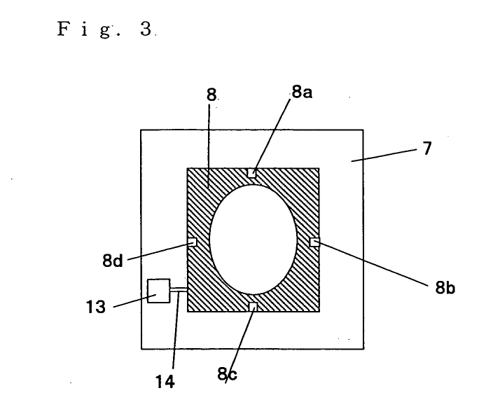

FIG. 3 is a schematic plan view showing the structure of the lower electrode 8 of the variable-shape mirror 6 of the embodiment. It should be noted that FIG. 3 shows a state where the lower electrode film 8 alone has been formed on the substrate 7. The lower electrode film 8 is formed as a single, continuous segment in the part indicated by hatching in FIG. 3. The lower electrode film 8 is connected, by a lead conductor 14, to a first electrode terminal 13, that is connected further to a drive circuit (unillustrated).

The lower electrode film 8 is formed so as to avoid the part of the substrate 7 corresponding to the part indicated by hatching in FIG. 2A. This is to permit the mirror film 12 to be formed directly on the substrate 7. The lower electrode film 8 is formed so as to avoid also the parts indicated by 8a to 8d in FIG. 3. This is to permit lead conductors 16a to 16d for the upper electrode film 10 to be formed there. The shape of the lower electrode film 8 is not limited to the one it specifically has in the embodiment, but may be modified within the objects of the present invention; for example, the lower electrode film 8 may be sized and shaped (though not divided into discrete segments) identically with the upper electrode film 10. The lower electrode film 8 may even be divided into two or more discrete segments.

The upper electrode film 10 forms a pair with the lower electrode film 8 to serve to apply a voltage across the piezoelectric film 9, which is sandwiched between the lower electrode film 8 and the upper electrode film 10. As shown in FIG. 2A, the upper electrode film 10 is divided into four discrete electrode film segments 10a to 10d, which are arranged to surround the mirror film 12. Among these electrode film segments 10a to 10d, each pair of oppositely located electrode film segments (i.e. 10a and 10c on one hand, and 10b and 10d on the other hand) is arranged symmetrically. The electrode film segments 10a to 10d are respectively connected, by lead conductors 16a to 16d, to second electrode terminals 15a to 15d, which are connected further to the driver circuit (unillustrated).

In the embodiment, since the upper electrode film 10 is divided into discrete segments, different voltages can be applied across different parts of the piezoelectric film 9 sandwiched between the electrode film segments 10a to 10d and the lower electrode film 8. This makes it possible to adjust the degree and direction in which to vary the shape of the piezoelectric film 9 sandwiched between the electrode film segments 10a to 10d and the lower electrode film 8, and thus to vary the shape of the mirror film 12 into the desired shape.

The lower electrode film 8 and the upper electrode film 10 are formed of a metal with a high electrical conductivity, for example a low-resistance material such as Au, Cu, Al, Ti, Pt, Ir, or an alloy thereof. Where the fabrication procedure of the variable-shape mirror 6 includes a process involving high-temperature processing, however, it is preferable to use a material resistant to high temperature. The lower electrode film 8 and the upper electrode film 10 are formed by, for example, a sputtering process or vapor deposition process; that is, any process may be used that can form thin films, and therefore there is no particular limitation to the thin-film formation process to be used.

The lower electrode film 8 and the piezoelectric film 9 may be formed of the same material, or may be formed of different materials. In the embodiment, the upper electrode film 10 is divided into four discrete segments, of which each pair of oppositely located ones is arranged symmetrically. This, however, is not meant to be any limitation; so long as the desired mirror shape can be obtained, the upper electrode film 10 too may be formed as a single, continuous segment, or may be divided into two, three, or five or more discrete segments.

The piezoelectric film 9 is formed on the lower electrode film 8, and is shaped identically with the lower electrode film 8. When a voltage is applied between the lower electrode film 8 and the upper electrode film 10, the piezoelectric film 9 expands or contracts according to the polarity of the voltage, and thereby varies the shape of the movable portion 7b, on which the mirror film 12 is formed, and hence the shape of the mirror film 12. The piezoelectric film 9 is formed of, for example, PZT (lead zirconate titanate, Pb(ZrₓTi₁₋ₓ)O₃)), but may instead be formed of any other piezoelectric ceramic; it may even be formed of a piezoelectric polymer or the like such as polyvinylidene fluoride. Particularly preferred is a piezoelectric material that has a high piezoelectric constant and that produces a large displacement under application of a voltage.

The piezoelectric film 9 is formed by, for example, a sputtering process, vapor deposition process, chemical vapor deposition (CVD) process, sol-gel process, or aerosol deposition (AD) process; that is, any process may be used that can form thin films, and therefore there is no particular limitation to the thin-film formation process to be used. The embodiment assumes the use of a single piezoelectric film 9 whose piezoelectric polarity is unidirectional. This however is not meant to be any limitation; for example, two or more types of piezoelectric film 9 may instead be used that have different piezoelectric polarities.

The mirror film 12 serves to reflect the laser beam emitted from the laser light source 2 (see FIG. 1) and the laser beam reflected from the recording medium 23 (see FIG. 1). Moreover, as the piezoelectric film 9 expands and contracts, the mirror film 12 varies its shape into the desired shape, thereby to serve to correct for aberrations, such as spherical aberration and coma aberration, that occur in the optical pickup apparatus 1 (see FIG. 1). In the embodiment, the mirror film 12 is formed oval so as to be able to properly correct for aberrations even when the laser beams is obliquely incident on the variable-shape mirror 6.

It is preferable that the mirror film 12 be formed of a high-reflectivity material; for example, it is formed as a film of a metal such as Au, Al, Ti, or Cr or an alloy thereof. The mirror film 12 may be composed of a plurality of films formed on one another. The mirror film 12 is formed by, for example, a sputtering process or vapor deposition process; that is, any process may be used that can form thin films, and therefore there is no particular limitation to the thin-film formation process to be used.

It is preferable that at least part of the driver portion 11, which is constituted by the lower electrode film 8, the upper electrode film 10, and the piezoelectric film 9, be arranged on the movable portion 7b as indicated by broken-line boxes in FIG. 2B. If no part of the driver portion 11 is located on the movable portion 7b, even when the driver portion 11 is driven, the mirror film 12 on the movable portion 7b hardly varies its shape. Moreover, it is preferable that the driver portion 11 be so arranged as to surround the mirror film 12 as in the embodiment. This permits the shape of the mirror film 12 to be varied efficiently as the driver portion 11 is driven.

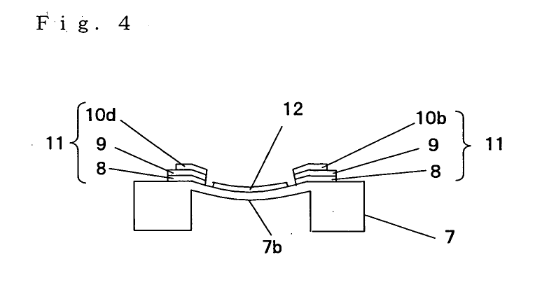

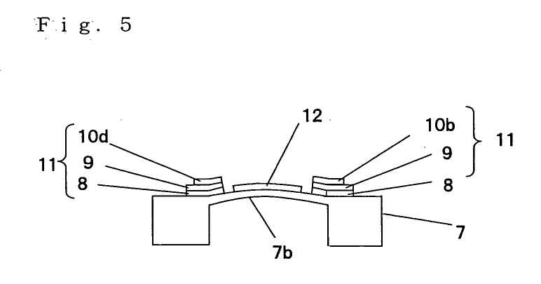

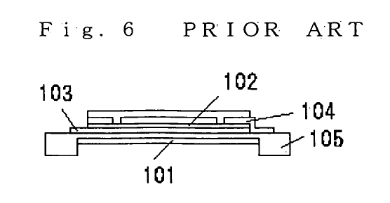

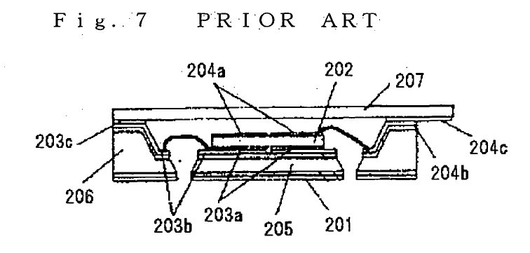

Next, the operation of the variable-shape mirror 6 structured as described above will be described. FIGS. 4 and 5 are diagrams showing how the variable-shape mirror 6 operates, FIG. 4 showing a state in which the piezoelectric film 9 has expanded from its state shown in FIG. 2B, FIG. 5 showing a state in which the piezoelectric film 9 has contracted from its state shown in FIG. 2B. In FIGS. 4 and 5, the voltage applied between the upper electrode film 10b and the lower electrode film 8 and the voltage applied between the upper electrode film 10d and the lower electrode film 8 are equal.

In FIG. 4, the piezoelectric film 9 expands, and thus a downward force acts on the movable portion 7b where the substrate 7 is movable; consequently, the movable portion 7b and the mirror film 12 bulges downward. By contrast, in FIG. 5, where the polarity of the voltage applied is the opposite of that in FIG. 4, the piezoelectric film 9 contracts, and thus an upward force acts on the movable portion 7b where the substrate 7 is movable; consequently, the movable portion 7b and the mirror film 12 bulges upward.

It should be understood that the operation of the variable-shape mirror 6 described above is merely an example; the shape of the variable-shape mirror 6 can be varied in different manners as the voltages applied between the individual electrode film segments 10a to 10d and the lower electrode film 8 are varied.

Next, an example of the fabrication procedure of the variable-shape mirror 6 of the embodiment will be described. First, one side of the substrate 7, which is formed as a flat plate, is etched to form the movable portion 7b (first step). Next, on the opposite side of the substrate 7, a metal mask or the like is formed in the part where to form the mirror film 12 (the part indicated by hatching in FIG. 2A) and in the parts where to form the lead conductors 16a to 16d for the upper electrode film 10 (second step). Thereafter, thin films are formed by a sputtering process or the like as described previously in the following order: the lower electrode film 8, then the piezoelectric film 9, and then the upper electrode film 10 (third to fifth steps).

Thereafter, the metal mask or the like formed in the second step is removed, and the mirror film 12 is formed directly on the substrate 7 by a sputtering process or the like (sixth step). Then, the conductors for the lower electrode film 8 and the upper electrode film 10 are patterned (seventh step).

Fabricated in this way, the variable-shape mirror 6 has the mirror film 12 formed on the side of the substrate 7 that is not processed by etching or the like. This helps produce a flat and smooth mirror surface. Moreover, the conductors for the lower electrode film 8 and the upper electrode film 10 too are patterned on the side of the substrate 7 that is not processed. This makes their patterning easy. Furthermore, the substrate 7 is formed thick in its part 7a other than the movable portion 7b. This ensures good handling during fabrication.

A variable-shape mirror 6 according to the present invention may be implemented in any manner other than specifically described above as an embodiment; that is, many modifications and variations are possible within the objects of the present invention. Specifically, for example, the driver portion 11 for varying the shape of the mirror film 12 may be arranged, instead of so as to surround the circumference of the mirror film 12, only in the parts, shown in FIG. 2A, where the upper electrode film segments 10a and 10c are arranged.

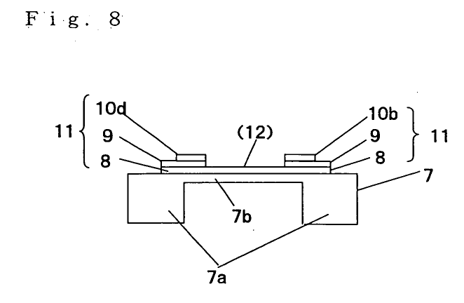

For another example, as shown in FIG. 8, the lower electrode film 8 and the mirror film 12 may be formed of the same material and integrally (as a single film). FIG. 8 is a schematic cross-sectional view, like FIG. 2B, of a variable-shape mirror 6 that has basically the same structure as that of the embodiment except that the lower electrode film 8 and the mirror film 12 are formed as a single film. Forming the lower electrode film 8 and the mirror film 12 as a single film provides the advantage of reducing the fabrication procedure of the variable-shape mirror 6.

For another example, the upper electrode film 10 and the mirror film 12 may be formed integrally. In that case, however, instead of the upper electrode film 10 being formed into discrete electrode segments, for example, the lower electrode film 8 may be formed into discrete electrode segments. Depending on the purpose, neither the upper electrode film 10 nor the lower electrode film 8 has to be formed into discrete electrode segments.

The embodiment deals with a case where a variable-shape mirror 6 according to the present invention is incorporated in an optical pickup apparatus 1; it should however be understood that variable-shape mirrors according to the present invention may also be applied to other optical apparatuses (e.g., optical apparatuses incorporated in digital cameras, projectors, and the like).

According to the present invention, a variable-shape mirror is provided with: a driver portion including a piezoelectric film and first and second electrode films that sandwich the piezoelectric film therebetween; a substrate supporting the driver portion and having part thereof formed into a movable portion by being made thinner; a mirror film formed directly on the movable portion so that, as the driver portion is driven, the mirror film varies the shape thereof. Here, the mirror film is formed on the side of the substrate opposite from the side thereof processed to form the movable portion, and is formed so as not to overlap the driver portion or so as to be integral with one of the first and second electrode films. Moreover, at least part of the driver portion is provided on the movable portion.

In this way, the driver portion and the mirror film can both be formed on the side of the substrate that is not processed. This makes it possible to obtain a flat and smooth mirror surface, and also permits the electrode pattern to be formed on the substrate with less wok burden.

Moreover, in the variable-shape mirror according to the present invention, the driver portion may be arranged around the mirror film. This makes it easy to fabricate a variable-shape mirror that permits the shape of the mirror to be varied efficiently as the driver portion is driven.

Moreover, in the variable-shape mirror according to the present invention, the driver portion may be arranged so as to surround the circumference of the mirror film. This makes it possible to vary the shape of the mirror efficiently as the driver portion is driven.

Moreover, in the variable-shape mirror according to the present invention, at least one of the first and second electrode films has a pattern divided into a plurality of discrete segments. This makes it possible to vary the shape of the mirror into the desired shape by use of a piezoelectric film whose piezoelectric polarity is unidirectional.

Moreover, an optical pickup apparatus incorporating a variable-shape mirror according to the present invention, since it incorporates a variable-shape mirror having a flat and smooth mirror surface, can correct for aberrations accurately. In addition, since the variable-shape mirror can be fabricated easily, the optical pickup apparatus can be fabricated with less work burden.

What is claimed is:

1. A variable-shape mirror comprising:
a driver portion including a piezoelectric film and first and second electrode films that sandwich the piezoelectric film therebetween;
a substrate supporting the driver portion and having part thereof formed into a movable portion by being made thinner;
a mirror film formed directly on the movable portion so that, as the driver portion is driven, the mirror film varies a shape thereof,
wherein the mirror film is formed on a side of the substrate opposite from a side thereof processed to form the movable portion, and is formed so as not to overlap the driver portion or so as to be integral with one of the first and second electrode films, and
wherein at least part of the driver portion is provided on the movable portion.

2. The variable-shape mirror according to claim 1,
wherein the driver portion is arranged around the mirror film.

3. The variable-shape mirror according to claim 1,
wherein at least one of the first and second electrode films has a pattern divided into a plurality of discrete segments.

4. The variable-shape mirror according to claim 2,
wherein the driver portion is arranged so as to surround an outer circumference of the mirror film.

5. The variable-shape mirror according to claim 2,
wherein at least one of the first and second electrode films has a pattern divided into a plurality of discrete segments.

6. The variable-shape mirror according to claim 4,
wherein at least one of the first and second electrode films has a pattern divided into a plurality of discrete segments.

7. An optical pickup apparatus comprising the variable-shape mirror according to claim 1.

8. An optical pickup apparatus comprising the variable-shape mirror according to claim 2.

9. An optical pickup apparatus comprising the variable-shape mirror according to claim 3.

10. An optical pickup apparatus comprising the variable-shape mirror according to claim 4.

11. An optical pickup apparatus comprising the variable-shape mirror according to claim 5.

12. An optical pickup apparatus comprising the variable-shape mirror according to claim 6.
